(19) United States
(12) Patent Application Publication
(10) Pub. No.: US 2025/0162328 A1
(43) Pub. Date: May 22, 2025

(54) TREATMENT AGENT APPLICATOR AND IMAGE FORMING APPARATUS

(71) Applicant: Hideki Tobinaga, KANAGAWA (JP)

(72) Inventor: Hideki Tobinaga, KANAGAWA (JP)

(73) Assignee: Ricoh Company, Ltd., Tokyo (JP)

(21) Appl. No.: 18/927,394

(22) Filed: Oct. 25, 2024

(30) Foreign Application Priority Data
Nov. 17, 2023 (JP) 2023-196213

(51) Int. Cl. B41J 11/00; B41J 13/02; B41M 5/00

(52) U.S. Cl. CPC B41J 11/0015; B41J 11/009; B41J 13/02; B41M 5/0017

(57) ABSTRACT

A treatment agent applicator includes an application roller to apply a treatment agent onto a recording medium conveyed in a conveyance direction; a driver to rotate the application roller; an encoder to detect a rotational speed of the driver; a drive circuit configured to perform feedback control on the driver to switch a linear velocity of the application roller based on the rotational speed detected by the encoder; and a controller configured to control the drive circuit to switch the linear velocity of the application roller according to a type of recording medium.

### CROSS-REFERENCE TO RELATED APPLICATIONS

This patent application is based on and claims priority pursuant to 35 U.S.C. § 119(a) to Japanese Patent Application No. 2023-196213, filed on Nov. 17, 2023, in the Japan Patent Office, the entire disclosure of which is hereby incorporated by reference herein.

### BACKGROUND

### Technical Field

The present embodiment relates to a treatment agent applicator and an image forming apparatus.

### Related Art

In an image generating apparatus performs image formation printing in an inkjet manner onto a medium, a treatment agent is applied onto the medium in an image formation process to improve image quality. Before the image formation process, the medium is supported by an application roller impregnated with the treatment agent and a conveyance roller positioned on a side facing the application roller via the medium. When the medium passes through the rollers, the treatment agent is applied onto the medium by the application roller.

### SUMMARY

In an aspect of the present disclosure, a treatment agent applicator is provided that includes an application roller to apply a treatment agent onto a recording medium conveyed in a conveyance direction; a driver to rotate the application roller; an encoder to detect a rotational speed of the driver; a drive circuit configured to perform feedback control on the driver to switch a linear velocity of the application roller based on the rotational speed detected by the encoder; and a controller configured to control the drive circuit to switch the linear velocity of the application roller according to a type of recording medium.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a view illustrating an example of an overall configuration of an image forming apparatus according to an embodiment;

FIG. 2 is a view illustrating another example of the overall configuration of the image forming apparatus according to the embodiment;

FIG. 3 is a view illustrating an example of a configuration of a pre-application unit in the image forming apparatus according to the embodiment;

FIG. 4 is a view illustrating an example of a configuration of an applicator of the pre-application unit in the image forming apparatus according to the embodiment;

FIG. 5 is a view illustrating an example of a configuration of an application roller of the applicator of the pre-application unit in the image forming apparatus according to the embodiment;

FIG. 6 is a view illustrating another example of the configuration of the application roller of the applicator of the pre-application unit in the image forming apparatus according to the embodiment;

FIG. 7 is a view illustrating an example of a hardware configuration of the image forming apparatus according to the embodiment;

FIG. 8 is a view for describing control operation for the application roller of the applicator of the pre-application unit in the image forming apparatus according to the embodiment;

FIG. 9 is a view illustrating an example of a configuration of functional blocks in the image forming apparatus according to the embodiment;

FIG. 10 is a view illustrating a relationship between a linear velocity of and an application amount by the application roller of the applicator of the pre-application unit in the image forming apparatus according to the embodiment;

FIG. 11 is a view illustrating an example of a lookup table of media and the linear velocities of the application roller;

FIG. 12 is a view for describing operation for switching a linear velocity of each roller in front of and behind the application roller of the applicator of the pre-application unit in the image forming apparatus according to the embodiment;

FIG. 13 is a view for describing the operation for switching the linear velocity of each of the rollers in front of and behind the application roller of the applicator of the pre-application unit in the image forming apparatus according to the embodiment;

FIG. 14 is a view for describing the operation for switching the linear velocity of each of the rollers in front of and behind the application roller of the applicator of the pre-application unit in the image forming apparatus according to the embodiment;

FIG. 15 is a view for describing the operation for switching the linear velocity of each of the rollers in front of and behind the application roller of the applicator of the pre-application unit in the image forming apparatus according to the embodiment;

FIG. 16 is a view for describing the operation for switching the linear velocity of each of the rollers in front of and behind the application roller of the applicator of the pre-application unit in the image forming apparatus according to the embodiment;

FIG. 17 is a view for describing the operation for switching the linear velocity of each of the rollers in front of and behind the application roller of the applicator of the pre-application unit in the image forming apparatus according to the embodiment;

FIG. 18 is a view for describing the operation for switching the linear velocity of each of the rollers in front of and behind the application roller of the applicator of the pre-application unit in the image forming apparatus according to the embodiment;

FIG. 19 is a view illustrating an example of a configuration of rollers immediately in front of the application roller of the applicator of the pre-application unit in the image forming apparatus according to a first modification example;

FIG. 20 is a view for describing a medium encoder for the rollers immediately in front of the application roller of the applicator of the pre-application unit in the image forming apparatus according to the first modification example;

FIG. 21 is a view for describing control operation for the application roller of the applicator of the pre-application unit in the image forming apparatus according to the first modification example;

FIG. 22 is a flowchart illustrating an example of a flow of control for the application roller of the applicator of the pre-application unit in the image forming apparatus according to the first modification example;

FIG. 23 is a view for describing that the treatment agent remains on the application roller of the applicator of the pre-application unit in the image forming apparatus according to a second modification example;

FIGS. 24A and 24B illustrate an example of a timing for decelerating the application roller of the applicator of the pre-application unit in the image forming apparatus according to the second modification example;

FIGS. 25A and 25B illustrate another example of the timing for decelerating the application roller of the applicator of the pre-application unit in the image forming apparatus according to the second modification example;

FIG. 26 is a view for describing that the treatment agent is applied onto a part of a second surface from the pressure roller of the applicator of the pre-application unit in the image forming apparatus according to a third modification example;

FIG. 27 is a view for describing that a difference occurs in image quality due to application of the treatment agent onto a part of the second surface from the pressure roller of the applicator of the pre-application unit in the image forming apparatus according to the third modification example;

FIGS. 28A and 28B illustrate an example of a timing for decelerating the application roller of the applicator of the pre-application unit in the image forming apparatus according to the third modification example; and

FIG. 29 is a view for describing application of machine learning to the image forming apparatus according to a fourth modification example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, an embodiment of a treatment agent applicator and an image forming apparatus according to the present embodiment will be described in detail with reference to the drawings. The present embodiment, however, is not limited to the embodiment described below, and the constituent elements of the embodiment include elements that may be easily conceived by those skilled in the art, those being substantially the same ones, and those being within equivalent ranges. Various omissions, substitutions, changes, and combinations of constituent elements can be made without departing from the gist of the embodiment described below.

### Overall Configuration of Image Forming Apparatus

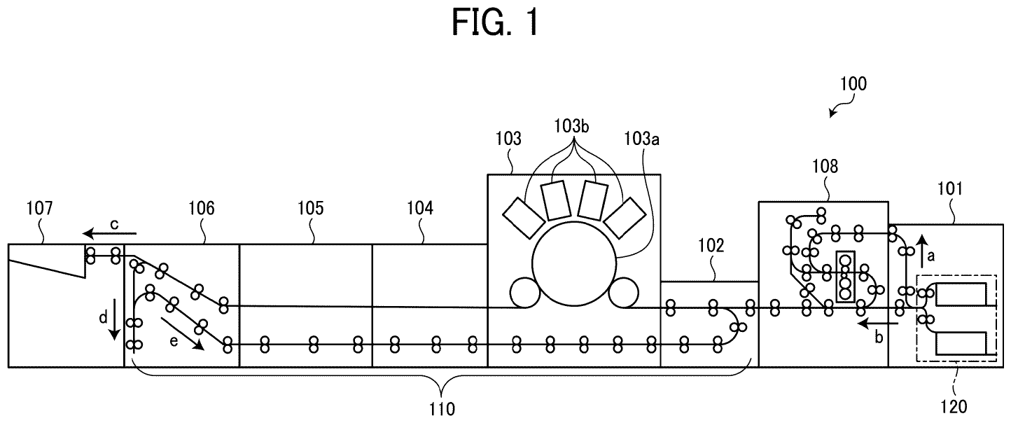

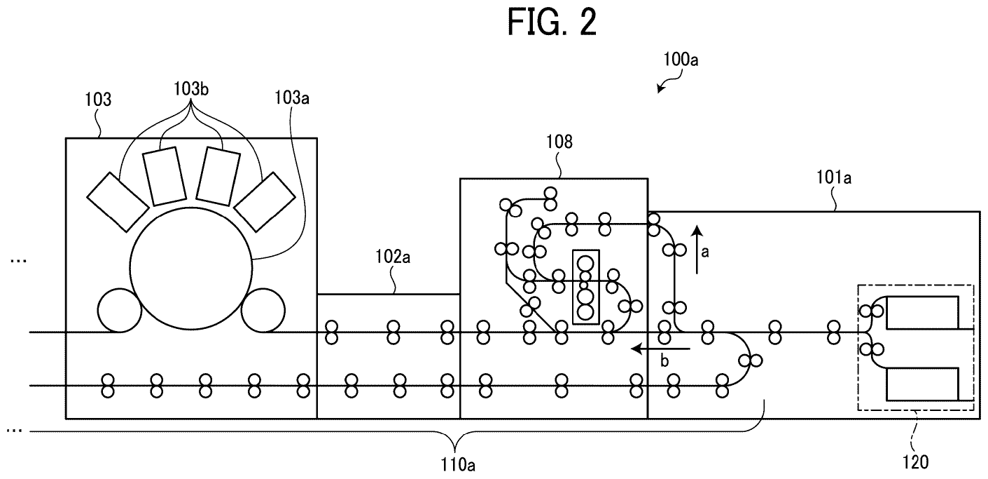

FIG. 1 is a view illustrating an example of an overall configuration of an image forming apparatus according to an embodiment. FIG. 2 is a view illustrating another example of the overall configuration of the image forming apparatus according to the embodiment. An overall configuration of an image forming apparatus 100 according to the present embodiment will be described with reference to FIGS. 1 and 2.

The image forming apparatus 100 illustrated in FIG. 1 is a commercial printer that uses an inkjet method to form an image on a medium (a recording medium) such as paper. The image forming apparatus 100 includes a sheet feeding unit 101, a pre-application unit 108 (a treatment agent applicator), a resist unit 102, an image formation unit 103, a drying unit 104, a cooling unit 105, a reversing unit 106, and a sheet ejection unit 107.

The sheet feeding unit 101 is a unit that separately conveys media one by one from a sheet feeding tray 120. A separately conveyed medium is fed to the pre-application unit 108. The sheet feeding unit 101 is able to switch a conveyance path for a medium between a case of performing pre-application of a treatment agent in the pre-application unit 108 and a case of not performing the pre-application. When pre-application is not to be performed, the sheet feeding unit conveys the medium along a path b illustrated in FIG. 1. When pre-application is to be performed, the sheet feeding unit conveys the medium along a path a. In the present embodiment, description is given by assuming that, on the premise that pre-application is performed on a medium in the pre-application unit 108, the sheet feeding unit 101 conveys the medium along the path a.

The pre-application unit 108 is a unit that applies the treatment agent for pre-application onto one side or both sides of a medium conveyed and fed along the path a from the sheet feeding unit 101. The medium having undergone pre-application of the treatment agent by the pre-application unit 108 is conveyed to the resist unit 102.

The resist unit 102 is a unit that corrects an attitude of the medium conveyed from the pre-application unit 108 to an appropriate attitude. The medium that has been corrected in attitude by the resist unit 102 is conveyed to the image formation unit 103.

The image formation unit 103 is a unit that discharges ink onto the medium conveyed from the resist unit 102 to perform image formation printing. As illustrated in FIG. 1, the image formation unit 103 includes an image formation conveyance drum 103a and inkjet heads 103b (discharge heads).

The image formation conveyance drum 103a is a conveyance drum that rotationally conveys the medium conveyed from the resist unit 102 to a side where the inkjet heads 103b lies. The inkjet heads 103b are discharge heads that discharge ink onto the medium conveyed by the image formation conveyance drum 103a to perform image formation printing.

The medium having undergone image formation printing by the image formation unit 103 is conveyed to the drying unit 104.

The drying unit 104 is a unit that dries the medium conveyed from the image formation unit 103. One drying unit 104 is provided in the example of the image forming apparatus 100 illustrated in FIG. 1. However, the present embodiment is not limited to the example. A plurality of drying units may be provided in accordance with drying conditions. The medium dried by the drying unit 104 is conveyed to the cooling unit 105.

The cooling unit 105 is a unit that cools the dried medium conveyed from the drying unit 104. The medium cooled by the cooling unit 105 is conveyed to the reversing unit 106.

The reversing unit 106 is a unit that reverses the medium by switching back the medium in a path d, and conveys the medium to a both-side conveyance path 110, as illustrated in FIG. 1, when printing is performed on both the sides of the medium conveyed from the cooling unit 105. The medium conveyed to the both-side conveyance path 110 is fed again to the resist unit 102. Image formation printing is performed on a second surface of the medium, which is a back surface with respect to a first surface of the medium, onto which image formation printing has already been performed in the image formation unit 103. When printing is performed only on one side of the medium conveyed from the cooling unit 105, the reversing unit 106 conveys the medium to the sheet ejection unit 107 through a path c, as illustrated in FIG. 1.

The sheet ejection unit 107 is a unit that ejects the medium conveyed from the reversing unit 106 to a sheet ejection tray.

Such an example has been illustrated that, when a medium that undergoes both-side printing is reversed by the reversing unit 106 in the image forming apparatus 100 illustrated in FIG. 1, the medium is fed again in the resist unit 102, that is, at a position on a downstream side of the pre-application unit 108. However, similar to an image forming apparatus 100a illustrated in FIG. 2, a position where a medium is to be fed again may be a position on an upstream side of the pre-application unit 108 to fed again the medium. Such an example is illustrated that, in the image forming apparatus 100a illustrated in FIG. 2, a medium is fed again by a sheet feeding unit 101a on the upstream side of the pre-application unit 108. In FIG. 2, since a configuration of the units on the downstream side of the image formation unit 103 are similar to those illustrated in FIG. 1, its illustration is omitted. The medium separately conveyed from the sheet feeding tray 120 in the sheet feeding unit 101a undergoes pre-application of the treatment agent in the pre-application unit 108, is corrected for its attitude in a resist unit 102a, and is conveyed to the image formation unit 103. In a case of both-side printing, similar to those illustrated FIG. 1, the medium is reversed in the reversing unit 106, is conveyed along a both-side conveyance path 110a, is fed again in the sheet feeding unit 101a on the upstream side of the pre-application unit 108, is conveyed again to the pre-application unit 108, and then, in the pre-application unit 108, is allowed to undergo pre-application of the treatment agent on the second surface that is the back surface with respect to the first surface that has already undergone pre-application and image formation printing, and is allowed to undergo image formation printing on the second surface in the image formation unit 103.

### Configuration of Pre-application Unit

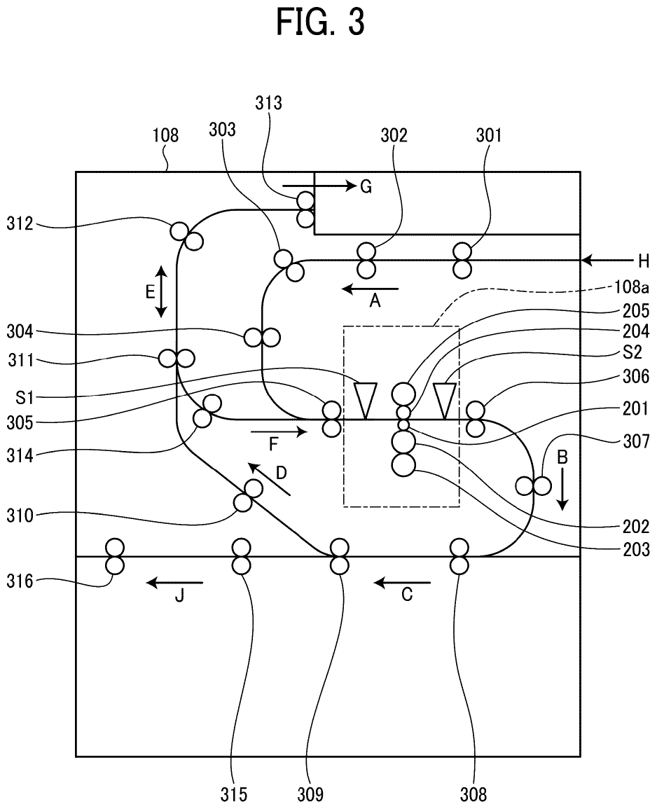

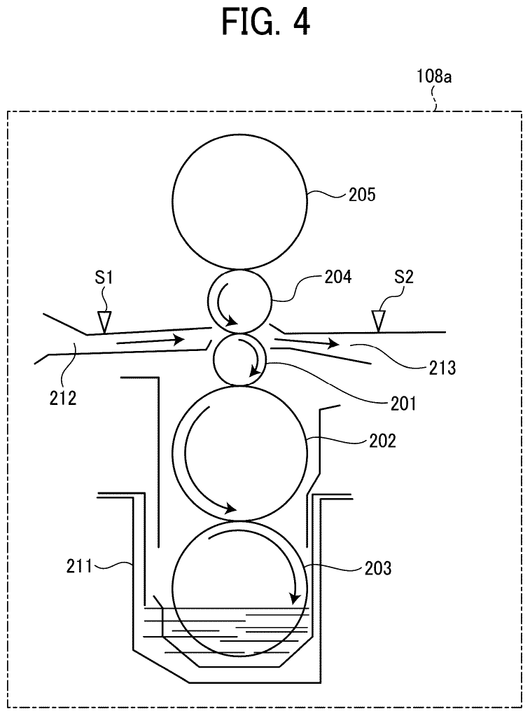

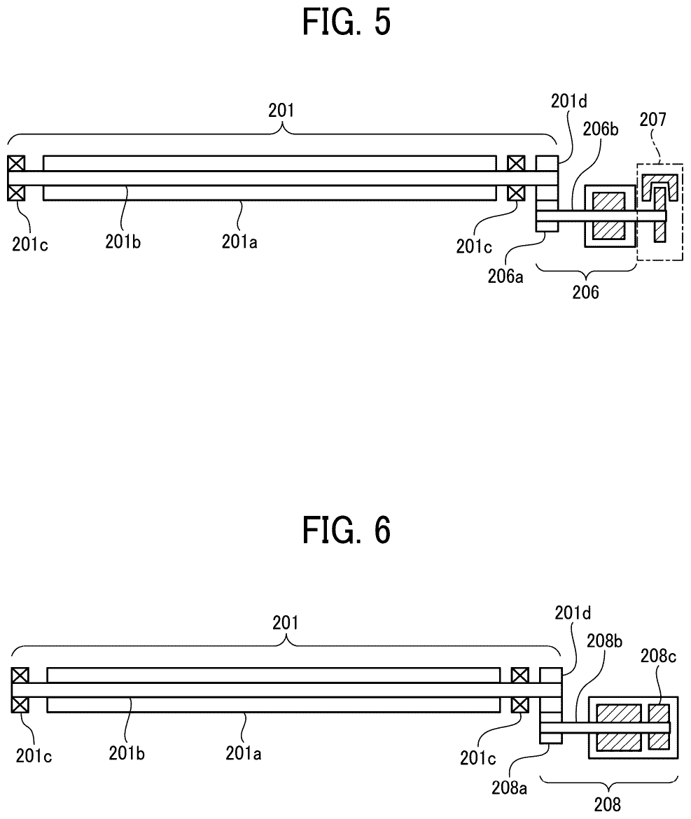

FIG. 3 is a view illustrating an example of a configuration of the pre-application unit in the image forming apparatus according to the embodiment. FIG. 4 is a view illustrating an example of a configuration of the applicator of the pre-application unit in the image forming apparatus according to the embodiment. FIG. 5 is a view illustrating an example of a configuration of the application roller of the applicator of the pre-application unit in the image forming apparatus according to the embodiment. FIG. 6 is a view illustrating another example of the configuration of the application roller of the applicator of the pre-application unit in the image forming apparatus according to the embodiment. The configuration of the pre-application unit 108 in the image forming apparatus 100 according to the present embodiment will be described with reference to FIGS. 3 to 6.

As illustrated in FIG. 3, the pre-application unit 108 includes an applicator 108a, inlet rollers 301 to 305, outlet rollers 306 to 309, purge rollers 310 to 313, re-inlet rollers 314, and outlet rollers 315 and 316.

The applicator 108a is a device that applies the treatment agent onto the medium that has entered the pre-application unit 108 in a direction H and has been conveyed by the inlet rollers 301 to 305. Details of the configuration of the applicator 108a will be described later.

The inlet rollers 301 to 305 are conveyance rollers that convey, in a direction A, the medium that has entered the pre-application unit 108 in the direction H to the applicator 108a.

The outlet rollers 306 to 309 are rollers that convey the medium applied with the treatment agent in the applicator 108a in directions B and C illustrated in FIG. 3. When the treatment agent is to be applied onto both the sides of the medium, the medium applied with the treatment agent onto the first surface in the applicator 108a is allowed to pass through the outlet rollers 306 to 309, and then is conveyed by the purge rollers 310 in a direction D by a separator. When the treatment agent is applied onto only one side of the medium, on the other hand, the medium applied with the treatment agent onto the first surface in the applicator 108a is allowed to pass through the outlet rollers 306 to 309, and is then conveyed to the resist unit 102 by the outlet rollers 315 and 316 in a direction J by the separator.

The purge rollers 310 are conveyance rollers that convey the medium applied with the treatment agent onto the first surface to the purge rollers 311 to 313 for switching back.

The purge rollers 311 to 313 are conveyance rollers that convey the medium conveyed by the purge rollers 310 in directions E and G illustrated in FIG. 3 for switching back.

The medium that has been switched back by the purge rollers 311 to 313 is conveyed again to the applicator 108a in a direction F by the re-inlet rollers 314 to undergo application of the treatment agent onto the second surface. It is also possible to use the path in the directions E and G by the purge rollers 311 to 313 as a purge path.

The re-inlet rollers 314 are conveyance rollers that convey the medium that has been switched back by the purge rollers 311 to 313 to the applicator 108a in the direction F.

The outlet rollers 315 and 316 are conveyance rollers that convey the medium conveyed in the directions B and C by the outlet roller 307 to 309 to the resist unit 102 in the direction J.

When the medium that has been reversed by the reversing unit 106 is fed again on the upstream side of the pre-application unit 108, similar to those in the image forming apparatus 100a illustrated in FIG. 2, it is also possible to apply the treatment agent on both the sides of the medium in the pre-application unit 108 before the medium is conveyed to the resist unit 102a. However, after the medium is applied with the treatment agent only onto the first surface in the pre-application unit 108 and is conveyed to the resist unit 102a, the medium may undergo image formation printing onto the first surface, and is conveyed along the both-side conveyance path 110a for application of the treatment agent onto the second surface in the pre-application unit 108. In this case, it is not necessary to switch back the medium in the pre-application unit 108. The pre-application unit 108 may then be configured without the purge rollers 310 to 313 and the re-inlet rollers 314.

Next, a specific configuration of the applicator 108a of the pre-application unit 108 will be described with reference to FIGS. 4 to 6.

As illustrated in FIG. 4, the applicator 108a includes an application roller 201, a fixed roller 202, a squeeze roller 203, a pressure roller 204, a holding roller 205, a treatment agent liquid pan 211, an inlet sensor S1, and an outlet sensor S2. As illustrated in FIG. 4, the squeeze roller 203, the fixed roller 202, the application roller 201, the pressure roller 204, and the holding roller 205 are arranged in this order from a lower side.

The application roller 201 is a roller that applies, through rotation operation, the treatment agent in a form of liquid, which is supplied from a surface of the fixed roller 202, onto a lower surface of the medium conveyed from an upstream conveyance path 212. Details of the configuration of the application roller 201 will be described later.

The fixed roller 202 is a roller that supplies, through rotation operation, the treatment agent supplied from the squeeze roller 203 to the application roller 201.

The squeeze roller 203 is a roller, which is impregnated with the treatment agent filled in the treatment agent liquid pan 211, that supplies, through rotation operation, the treatment agent to the fixed roller 202. The squeeze roller 203 also has a function of stirring the treatment agent filled in the treatment agent liquid pan 211.

The pressure roller 204 is a roller that presses the application roller 201 from above. When the medium is conveyed from the upstream conveyance path 212 to the application roller 201, the pressure roller 204 presses the medium against the application roller 201.

The holding roller 205 is a roller that applies a load downward to the pressure roller 204 and the application roller 201, and rotates together with the pressure roller 204 in a linked manner.

The medium conveyed from the upstream conveyance path 212 is applied with the treatment liquid by the application roller 201, and is then conveyed to a side where the outlet roller 306 lies, as illustrated in FIG. 3, via a downstream conveyance path 213. The application roller 201, the fixed roller 202, the squeeze roller 203, and the pressure roller 204 described above are rotated by a motor 206 representing a single drive source described later. Among the rollers, the application roller 201 and the squeeze roller 203 rotate clockwise in a paper-face view of drawing of FIG. 4, and the fixed roller 202 and the pressure roller 204 rotate counterclockwise in the paper-face view.

The treatment agent liquid pan 211 is a pan that stores the treatment agent in the form of liquid.

The inlet sensor S1 is a sensor that detects the medium conveyed along the upstream conveyance path 212. The outlet sensor S2 is a sensor that detects the medium that is applied with the treatment agent by the application roller 201 and is conveyed along the downstream conveyance path 213.

As illustrated in FIG. 5, the application roller 201 includes a roller main body 201a, a roller cored bar 201b, bearings 201c, and a reduction gear 201d.

The roller main body 201a is a roller portion serving as a main body of the application roller 201. The roller cored bar 201b is a metal bar member penetrating the roller main body 201a in an axial direction. The bearings 201c are bearing members that support both ends of the roller cored bar 201b. The reduction gear 201d is a gear fixed to an end of one of the bearings 201c.

The applicator 108a further includes the motor 206 (an example of a driver) and an encoder 207 (an example of a first encoder) illustrated in FIG. 5. The motor 206 includes a motor shaft 206b that is rotationally driven and thus is rotated and a motor gear 206a fixed to a front end of the motor shaft 206b.

As illustrated in FIG. 5, the reduction gear 201d and the motor gear 206a mesh with each other. When the motor shaft 206b is rotationally driven by the motor 206 and is thus rotated, the application roller 201 is rotated via the motor gear 206a and the reduction gear 201d. The application roller 201 has a degree of freedom in a vertical direction, and thus has a configuration allowing displacement in the vertical direction as the application roller is pressed.

The encoder 207 is a sensor that detects a rotational speed of the motor 206. The encoder 207 transmits the detected rotational speed of the motor 206 to an applicator roller driver 411 described later.

The applicator 108a may include a motor 208 (an example of a driver) with a built-in encoder illustrated in FIG. 6, instead of the motor 206 that rotates the application roller 201.

The motor 208 illustrated in FIG. 6 includes a motor shaft 208b that is rotationally driven and is thus rotated, a motor gear 208a fixed to a front end of the motor shaft 208b, and an encoder 208c (an example of a first encoder) incorporated in a main body of the motor 208. In this case, when the reduction gear 201d and the motor gear 208a mesh with each other, and the motor shaft 208b is rotationally driven by the motor 208 and is thus rotated, the application roller 201 is rotated via the motor gear 208a and the reduction gear 201d. Description will be given hereinafter by assuming that the applicator 108a includes the motor 206 illustrated in FIG. 5.

### Hardware Configuration of Image Forming Apparatus

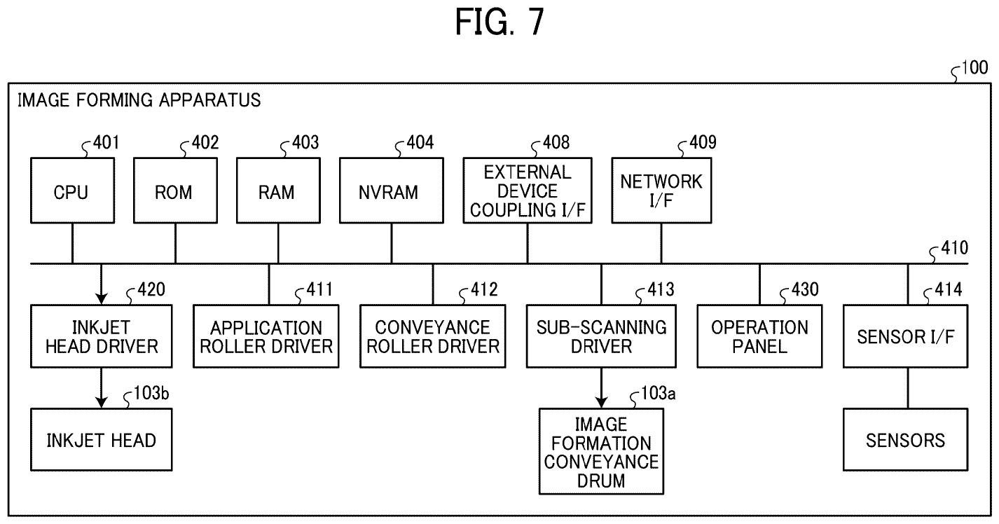

FIG. 7 is a view illustrating an example of a hardware configuration of the image forming apparatus according to the embodiment. The hardware configuration of the image forming apparatus 100 according to the present embodiment will be described with reference to FIG. 7.

As illustrated in FIG. 7, the image forming apparatus 100 includes a central processing unit (CPU) 401, a read only memory (ROM) 402, a random access memory (RAM) 403, a non-volatile random access memory (NVRAM) 404, an external device coupling interface (I/F) 408, a network I/F 409, the applicator roller driver 411 (a first drive circuit), a conveyance roller driver 412 (a second drive circuit), a sub-scanning driver 413, a sensor I/F 414, an inkjet head driver 420, and an operation panel 430.

The CPU 401 is an arithmetic device that wholly controls the image forming apparatus 100. The ROM 402 is a non-volatile storage device that stores programs such as an initial program loader (IPL). The RAM 403 is a volatile storage device that the CPU 401 uses as a work area.

The NVRAM 404 is a non-volatile storage device that stores various data such as programs, and holds the various data even while a power supply to the image forming apparatus 100 is cut off.

The external device coupling I/F 408 is an interface that is coupled to an external device such as a personal computer (PC) via a universal serial bus (USB) cable, and communicates with the external device for a control signal and data for printing, for example.

The network I/F 409 is an interface conforming to transmission control protocol (TCP)/internet protocol (IP) for performing data communication via the Internet or a local area network (LAN), for example. The network I/F 409 may be an interface for wired communication conforming to Ethernet (registered trademark), or may be an interface for wireless communication conforming to Wi-Fi (registered trademark), for example.

The applicator roller driver 411 is a drive circuit that drives the motor 206 that rotates the application roller 201 of the pre-application unit 108.

The conveyance roller driver 412 is a drive circuit that rotationally drives the inlet rollers 301 to 305, the outlet rollers 306 to 309, the purge rollers 310 to 313, the re-inlet rollers 314, and the outlet rollers 315 and 316 of the pre-application unit 108 independently.

The sub-scanning driver 413 is a drive circuit that rotationally drives the image formation conveyance drum 103a of the image formation unit 103 for conveying the medium in a conveyance direction, that is, a sub-scanning direction.

The sensor I/F 414 is an interface for receiving signals detected by sensors such as the inlet sensor S1 and the outlet sensor S2.

The inkjet head driver 420 is a drive circuit that controls the inkjet heads 103b for discharging operation.

The operation panel 430 is a device that includes a touch panel that receives an operation input from a user, and displays setting information and various screens, for example, related to the image forming apparatus 100, and includes an alarm lamp, for example.

The CPU 401, the ROM 402, the RAM 403, the NVRAM 404, the external device coupling I/F 408, the network I/F 409, the applicator roller driver 411, the conveyance roller driver 412, the sub-scanning driver 413, the sensor I/F 414, the inkjet head driver 420, and the operation panel 430 are able to perform data communication with each other via a bus 410 that is an address bus or a data bus, for example.

The hardware configuration of the image forming apparatus 100 illustrated in FIG. 7 illustrates a mere example. It is not necessary to include all the components illustrated in FIG. 7. Another component may be included.

### Control Operation for Application Roller

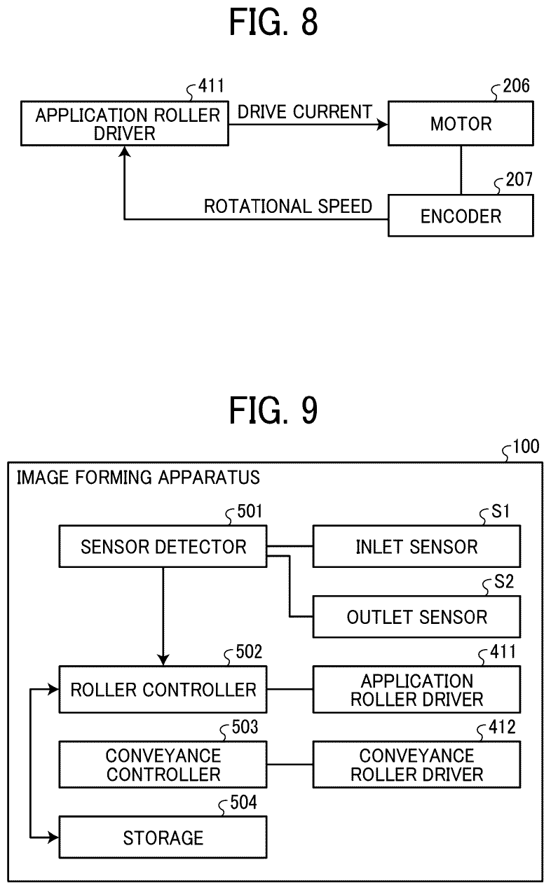

FIG. 8 is a view for describing control operation for the application roller of the applicator of the pre-application unit in the image forming apparatus according to the embodiment. Control operation for the applicator 108a of the pre-application unit 108 in the image forming apparatus 100 according to the present embodiment will be described with reference to FIG. 8.

As described above, the applicator roller driver 411 outputs a drive current to the motor 206 that rotates the application roller 201 to allow the motor 206 to rotate. Then, the encoder 207 detects the rotational speed of the motor 206, and feeds back the detected rotational speed to the applicator roller driver 411. That is, the applicator roller driver 411 performs feedback control of comparing a rotational speed (a target rotational speed) that has been set with a rotational speed that has been fed back from the encoder 207 to rotate the motor 206 at the target rotational speed, making it possible to allow the application roller 201 to rotate at a desired linear velocity. It is desirable that the motor 206 be an alternating current (AC) servomotor presenting high output and high responsiveness.

### Configuration and Operation of Functional Blocks in Image Forming Apparatus

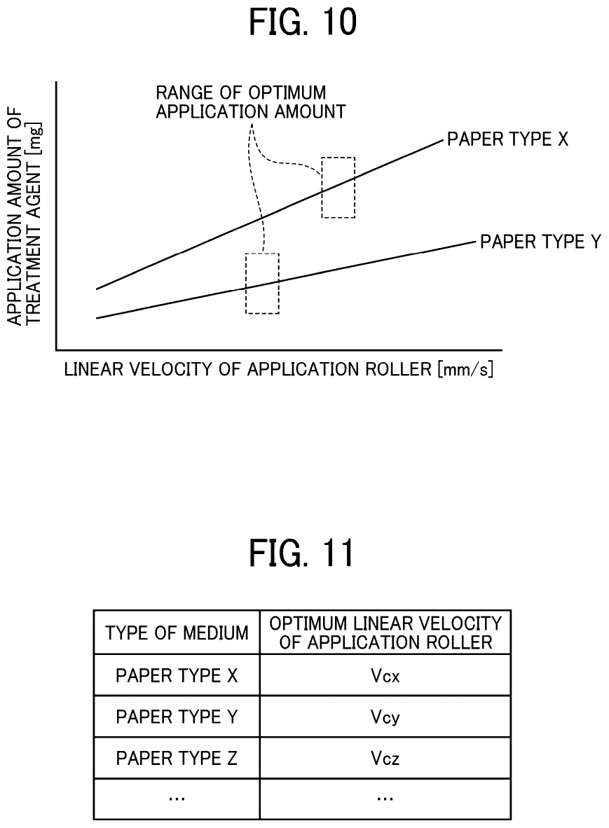

FIG. 9 is a view illustrating an example of a configuration of functional blocks in the image forming apparatus according to the embodiment. FIG. 10 is a view illustrating a relationship between a linear velocity of and an application amount from the application roller of the applicator of the pre-application unit in the image forming apparatus according to the embodiment. FIG. 11 is a view illustrating an example of a lookup table of media and the linear velocities of the application roller. The configuration and operation of the functional blocks in the image forming apparatus 100 according to the present embodiment will be described with reference to FIGS. 9 to 11.

As illustrated in FIG. 10, a linear velocity of the application roller 201 and an application amount of the treatment agent applied onto a medium from the application roller 201 have a linear relationship. That is, as the linear velocity of the application roller 201 increases, the amount of the treatment agent applied from the application roller 201 increases. If an optimum application amount for each medium (for example, paper types X and Y illustrated in FIG. 10) is known, allowing the application roller 201 to rotate at a linear velocity corresponding to the optimum application amount makes it therefore possible to uniformly apply the treatment agent onto the medium at the optimum application amount for stable image formation onto the medium.

It is then assumed that such a lookup table as illustrated in FIG. 11, in which types of media and optimum linear velocities of the application roller 201 are associated with each other, is stored in advance in a storage 504 described later.

As illustrated in FIG. 9, the image forming apparatus 100 includes a sensor detector 501, a roller controller 502 (a first controller), a conveyance controller 503 (a second controller), and the storage 504.

The sensor detector 501 is a functional portion that acquires, via the sensor I/F 414, a detection signal indicating that a medium has been detected by the inlet sensor S1 and the outlet sensor S2.

The roller controller 502 is a functional portion that controls rotation of the application roller 201 via the applicator roller driver 411. Specifically, the roller controller 502 refers to the lookup table that is described above and is stored in the storage 504, and allows the application roller 201 to rotate at an optimum linear velocity corresponding to a type, which has been set in advance, of the medium conveyed into the image forming apparatus 100.

The conveyance controller 503 is a functional portion that independently controls, via the conveyance roller driver 412, rotation of the inlet rollers 301 to 305, the outlet rollers 306 to 309, the purge rollers 310 to 313, the re-inlet rollers 314, and the outlet rollers 315 and 316 of the pre-application unit 108.

The storage 504 is a functional portion that stores the lookup table described above, for example. The storage 504 is implemented by the ROM 402 or the NVRAM 404 illustrated in FIG. 7.

The sensor detector 501, the roller controller 502, and the conveyance controller 503 described above are implemented by the CPU 401 illustrated in FIG. 7 executing a program. At least some of the sensor detector 501, the roller controller 502, and the conveyance controller 503 may be implemented by a hardware circuit such as a field-programmable gate array (FPGA) or an application specific integrated circuit (ASIC).

Each functional portion in the image forming apparatus 100 illustrated in FIG. 9 merely schematically illustrates a function. The present embodiment is not limited to such a configuration as described above. That is, each functional portion in the image forming apparatus 100 is not necessarily configured as a clear software module representing each of the blocks illustrated in FIG. 9. The function of each functional portion may be implemented as a whole as the image forming apparatus 100 executes a program. For example, a plurality of functional portions each illustrated as independent functional portions in the image forming apparatus 100 illustrated in FIG. 9 may be configured as one functional portion. In the image forming apparatus 100 illustrated in FIG. 9, on the other hand, the function of one functional portion may be divided into a plurality of parts and configured as a plurality of functional portions.

### Medium Conveyance Control Implemented by Conveyance Roller Inside Pre-Application Unit

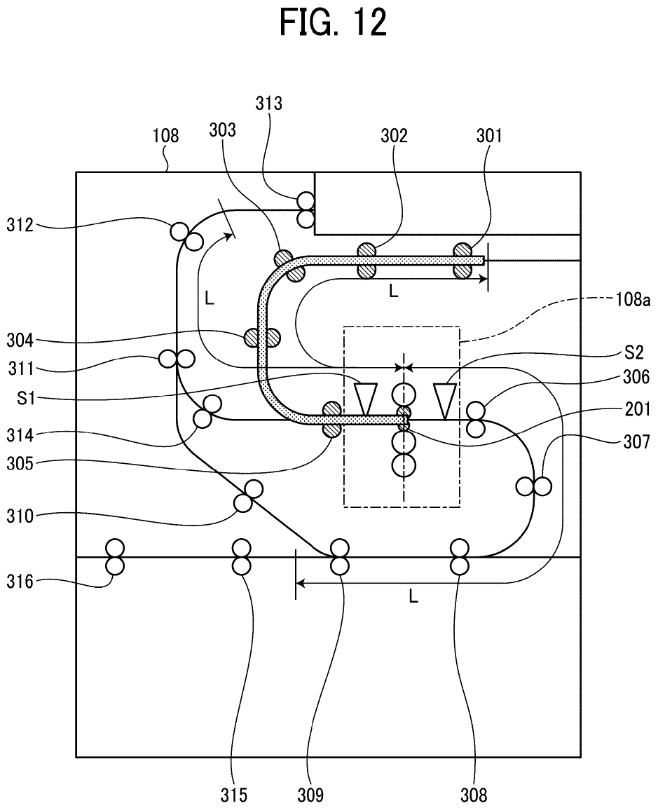

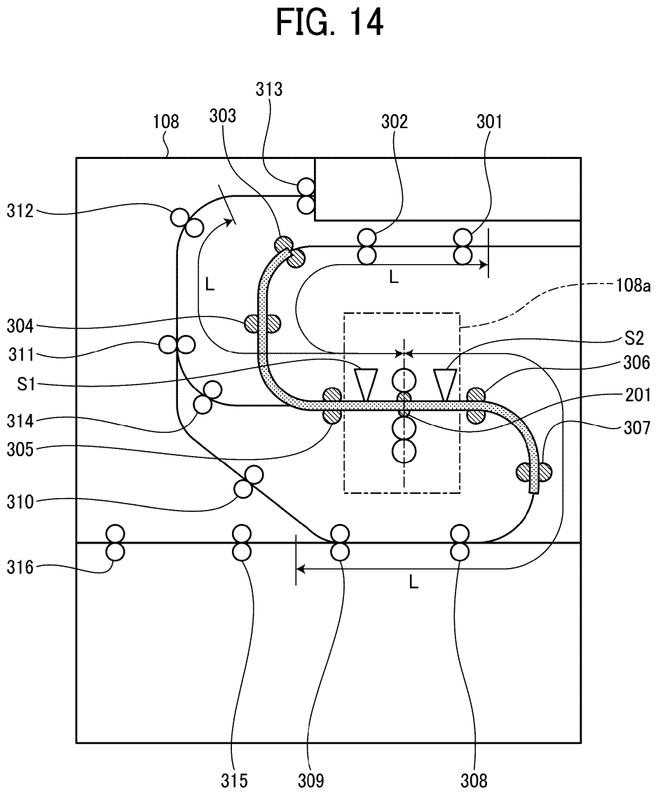

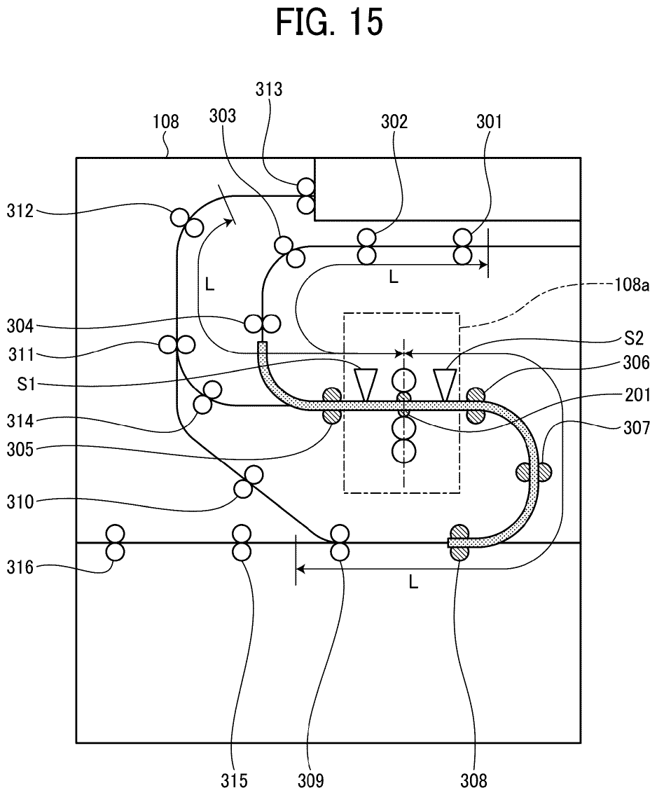

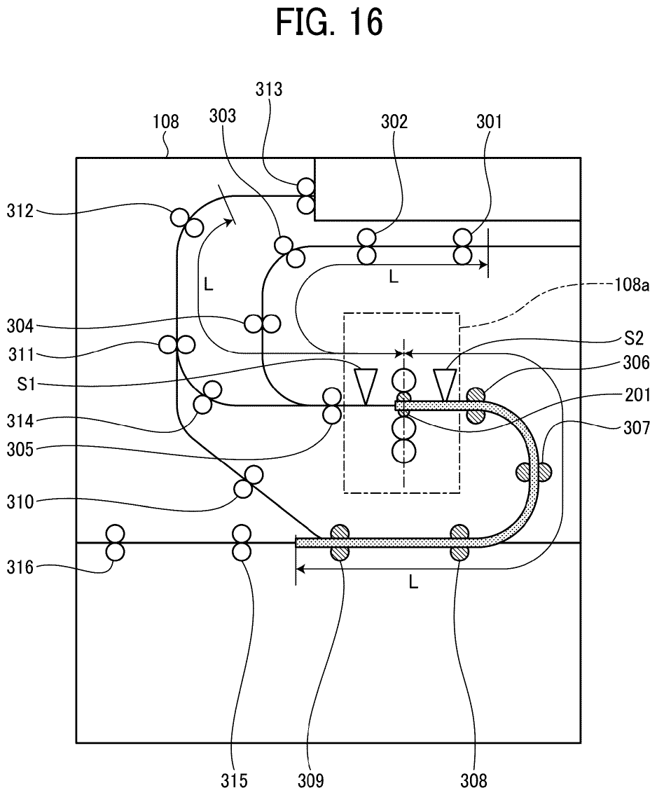

FIGS. 12 to 18 are views for describing operation for switching a linear velocity of each roller in front of and behind the application roller of the applicator of the pre-application unit in the image forming apparatus according to the embodiment. Medium conveyance control implemented by each conveyance roller inside the pre-application unit 108 in the image forming apparatus 100 according to the present embodiment will be described with reference to FIGS. 12 to 18.

When there is only a slight difference between a conveyance linear velocity V1 of the pre-application unit 108 and a linear velocity Vc of the application roller 201, it is possible to absorb the difference by creating a deflection space by providing a portion with an increased gap amount of a guide plate for a conveyance path. However, when there is an increase in difference between the conveyance linear velocity V1 and the linear velocity Vc, there is a possibility that the deflection space of the guide plate may not be able to fully absorb the difference, leading to an abnormality such as a damaged or broken medium or a paper jam. Then, when a length, in the conveyance direction, of a medium is designated as L, and a linear velocity of each conveyance roller within a range of the length L on the upstream side of and the range of the length L on the downstream side of an application position of the application roller 201 at maximum is synchronized (that is, coincide) with the linear velocity Vc until a rear end of the medium passes through the application roller 201 after a front end of the medium has reached the application roller 201, it is possible to secure medium conveyance stability when the application roller 201 applies the treatment agent. The operation will be described herein in detail.

When the front end of the medium has reached the application position of the application roller 201, as illustrated in FIG. 12, the conveyance controller 503 first switches the conveyance linear velocity V1 of each of the inlet rollers 301 to 305 existing within the range of the length L on the upstream side of the application position of the application roller 201 to be coincide with the linear velocity Vc of the application roller 201. The conveyance controller 503 may determine that, when the sensor detector 501 has detected that the inlet sensor S1 has detected the medium, for example, the front end of the medium has reached the application position of the application roller 201. FIGS. 12 to 18 illustrate that the conveyance linear velocity V1 of each of the conveyance rollers that are hatched is switched to the linear velocity Vc, and the conveyance linear velocity V1 of each of the conveyance rollers that are not hatched is kept at an original linear velocity (a linear velocity that has not been switched to the linear velocity Vc or a linear velocity before switched to the linear velocity Vc.).

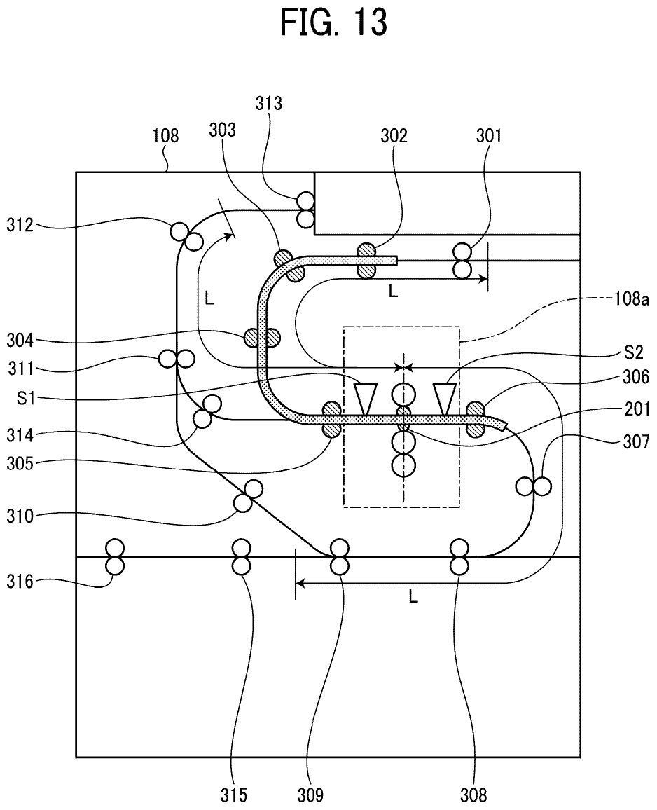

Then, as illustrated in FIGS. 13 to 16, the conveyance controller 503 sequentially switches the conveyance linear velocity V1 of a next conveyance roller to be coincide with the linear velocity Vc until the front end of the medium, which has passed through the application roller 201, reaches the next conveyance roller. As illustrated in FIGS. 13 to 16, the conveyance controller 503 sequentially switches the conveyance linear velocity V1 of the conveyance roller through which the rear end of the medium has passed to the original linear velocity.

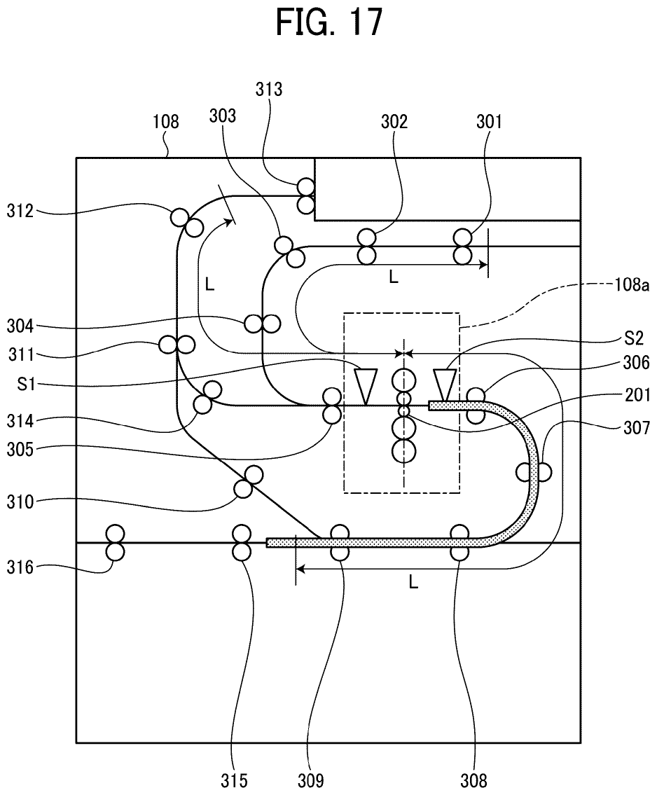

Then, when the rear end of the medium has passed through the application roller 201, as illustrated in FIG. 17, the conveyance controller 503 switches the conveyance linear velocity V1 of the conveyance roller, which has been switched to be coincide with the linear velocity Vc, to the original linear velocity. When the sensor detector 501 has detected that the outlet sensor S2 no longer detects the medium, for example, the conveyance controller 503 may determine that the rear end of the medium has passed through the application roller 201.

As illustrated in FIG. 18, when switching back has been performed by the purge rollers 311 to 313 for application of the treatment agent onto the second surface of the medium, and when the front end of the medium has reached the application position of the application roller 201, the conveyance controller 503 switches the conveyance linear velocity V1 of each of the purge rollers 311 and 312, the re-inlet rollers 314, and the inlet rollers 305 existing within the range of the length L on the upstream side of the application position of the application roller 201 to be coincide with the linear velocity Vc of the application roller 201. When the sensor detector 501 has detected that the inlet sensor S1 has detected the medium, for example, the conveyance controller 503 may determine that the front end of the medium has reached the application position of the application roller 201. Later steps of switching operation for the conveyance linear velocity V1 of each of the conveyance rollers are similar to those illustrated in FIGS. 13 to 18 described above.

Control for the conveyance rollers illustrated in FIGS. 12 to 18 illustrates a mere example. It is sufficient that the conveyance controller 503 may control rotation of the conveyance rollers to convey a medium at a linear velocity corresponding to a type of the medium at least within the range of the length L in the conveyance direction of the medium on the upstream side of the application position of the application roller 201 and within the range of the length L on the downstream side of the application position.

Performing switching operation for the conveyance linear velocity V1 of each conveyance roller of the pre-application unit 108 as described above makes it possible to reduce occurrence of an abnormality such as a damaged or broken medium or a paper jam.

The treatment agent applicator includes: multiple conveyance rollers in a conveyance path upstream and downstream of the application roller, multiple conveyance rollers to convey the recording medium; another drive circuit configured to rotate the multiple conveyance rollers, independently; and another circuitry configured to control said another drive circuit, wherein said another circuitry controls a rotation of the multiple conveyance rollers to convey the recording medium at a linear velocity corresponding to the type of recording medium, at least in a range: from an application position of the application roller to a point upstream of the application position for a length of the recording medium in the conveyance direction, and from the application position to a point downstream of the application position for the length of the recording medium in the conveyance direction.

In the image forming apparatus 100 according to the present embodiment, as described above, the application roller 201 applies the treatment agent onto a recording medium that has been conveyed. The motor 206 rotationally drives the application roller 201. The encoder 207 detects a rotational speed of the motor 206. The applicator roller driver 411 uses the rotational speed detected by the encoder 207 to perform feedback control on the motor 206. It is therefore possible to change the linear velocity of the application roller 201. The roller controller 502 then controls operation of the applicator roller driver 411 and switches the linear velocity of the application roller 201 via the applicator roller driver 411 in accordance with a type of the medium.

It is therefore possible to uniformly apply the treatment agent onto the medium that varies in type.

In the image forming apparatus 100 according to the present embodiment, the motor 206 is an alternating current servo motor (AC servomotor). It is therefore possible to use a general-purpose means to implement feedback control.

In the image forming apparatus 100 according to the present embodiment, the plurality of conveyance rollers (the inlet rollers 301 to 305, the outlet rollers 306 to 309, the purge rollers 310 to 313, and the re-inlet rollers 314) is disposed on the upstream and downstream sides of the application roller 201 to convey a medium. The conveyance roller driver 412 independently rotationally drives the plurality of conveyance rollers. The conveyance controller 503 controls operation of the conveyance roller driver 412, and controls rotation of the plurality of conveyance rollers to convey the medium at a linear velocity corresponding to a type of the medium at least within the range of the length L in the conveyance direction of the medium on the upstream side of the application position of the application roller 201 and within the range of the length L on the downstream side of the application position. It is therefore possible to reduce occurrence of an abnormality such as a damaged or broken medium or a paper jam.

### First Modification Example

The image forming apparatus 100 according to a first modification example will be described by focusing on differences from the image forming apparatus 100 according to the embodiment described above. In the present modification example, description will be given for operation of feedback control using the conveyance rollers and a medium encoder disposed immediately in front of the application roller 201. An overall configuration, a hardware configuration, and a configuration of functional blocks in the image forming apparatus 100 according to the present modification example are similar or identical to those described in the embodiment described above.

### Configuration of Applicator

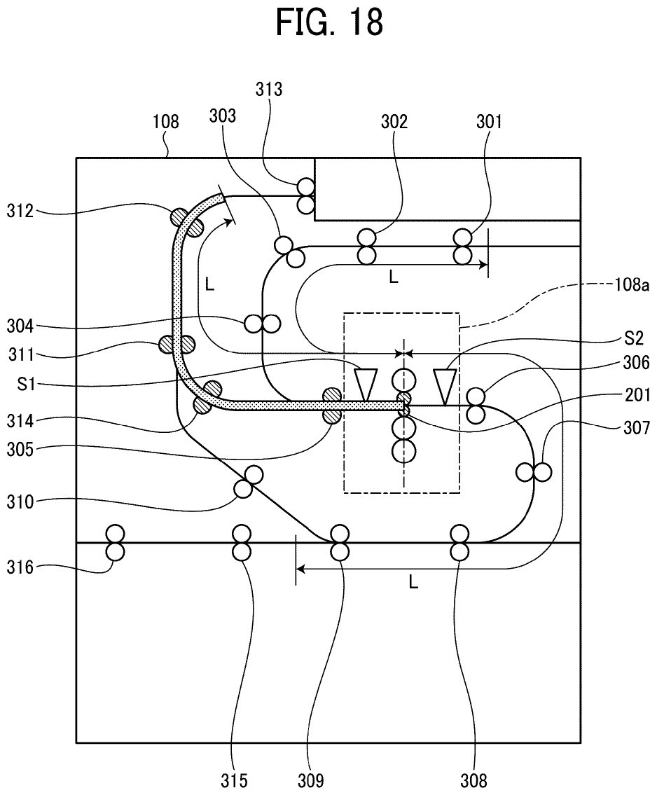

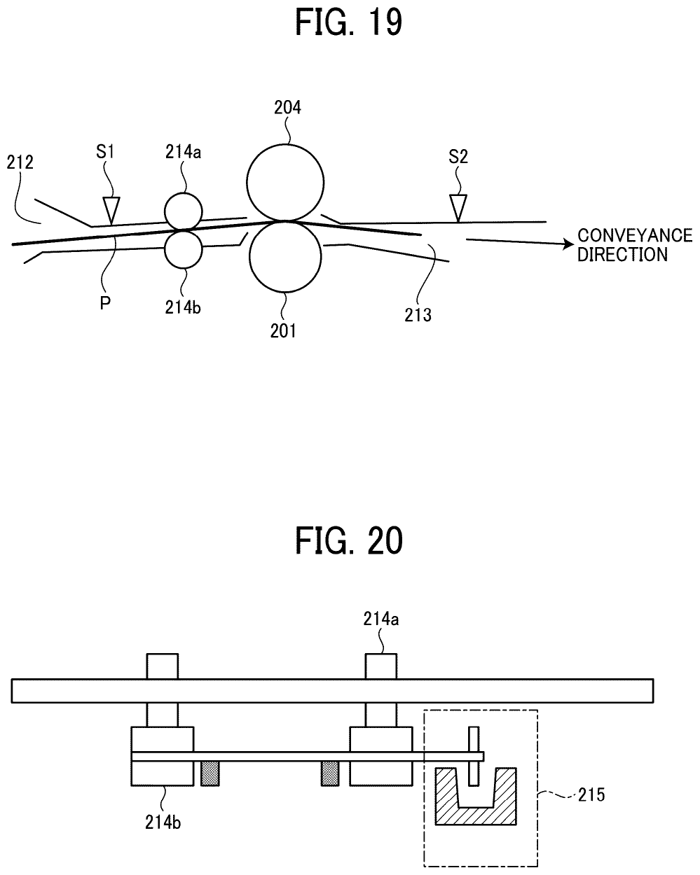

FIG. 19 is a view illustrating an example of a configuration of rollers immediately in front of the application roller of the applicator of the pre-application unit in the image forming apparatus according to the first modification example. FIG. 20 is a view illustrating a medium encoder for the rollers immediately in front of the application roller of the applicator of the pre-application unit in the image forming apparatus according to the first modification example. The configuration of the applicator 108a of the pre-application unit 108 in the image forming apparatus 100 according to the present embodiment will be described with reference to FIGS. 19 and 20.

As illustrated in FIGS. 19 and 20, the applicator 108a according to the present modification example includes the application roller 201, the pressure roller 204, the inlet sensor S1, the outlet sensor S2, a drive roller 214a, a driven roller 214b, and a medium encoder 215 (a second encoder). Other configurations of the applicator 108a are similar or identical to the configurations of the applicator 108a illustrated in FIG. 4 described above.

The drive roller 214a is a roller that is disposed on the upstream side, in the conveyance direction, of the application roller 201, is rotationally driven by the motor 206 that is a single drive source also for the application roller 201, and conveys a medium to the application roller 201 together with the driven roller 214b facing the drive roller. The driven roller 214b is a roller that is disposed to face the drive roller 214a, and rotates in line with rotational drive of the drive roller 214a. As illustrated in FIG. 20, the medium encoder 215 is a sensor that is provided coaxially with a rotation shaft of the driven roller 214b provided with a pressurizing mechanism, and detects a linear velocity of a medium through rotation of the driven roller 214b. That is, the medium encoder 215 detects the linear velocity of the medium conveyed on the upstream side, in the conveyance direction, of the application roller 201.

### Control Operation for Application Roller

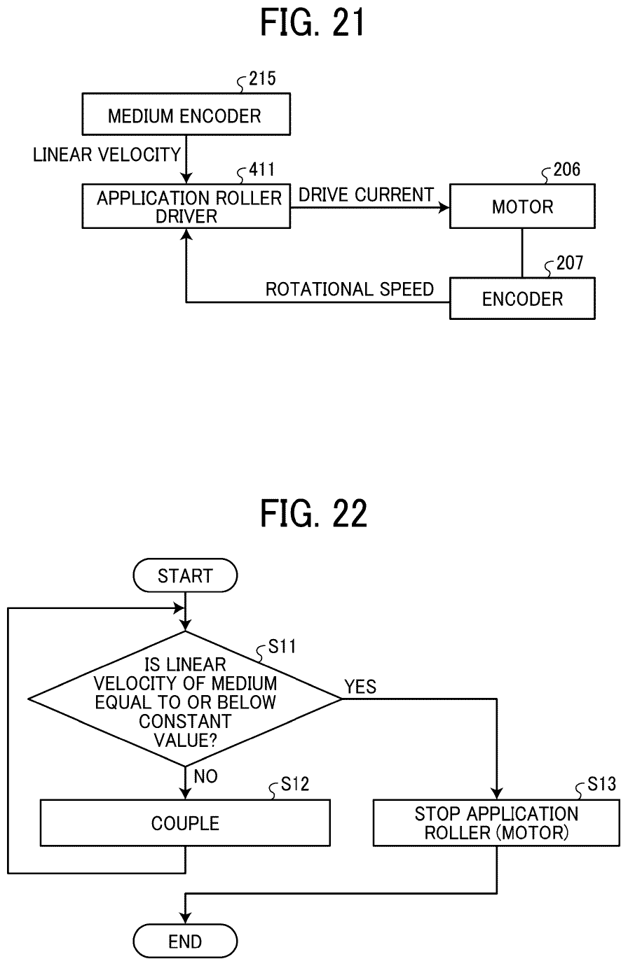

FIG. 21 is a view for describing control operation for the application roller of the applicator of the pre-application unit in the image forming apparatus according to the first modification example. Control operation for the applicator 108a of the pre-application unit 108 in the image forming apparatus 100 according to the present modification example will be described with reference to FIG. 21.

The applicator roller driver 411 outputs a drive current to the motor 206 that rotates the application roller 201 to allow the motor 206 to rotate. Then, the encoder 207 detects the rotational speed of the motor 206, and feeds back the detected rotational speed to the applicator roller driver 411. That is, the applicator roller driver 411 performs feedback control of comparing a rotational speed (a target rotational speed) that has been set with a rotational speed that has been fed back from the encoder 207 to rotate the motor 206 at the target rotational speed, making it possible to allow the application roller 201 to rotate at a desired linear velocity. It is desirable that the motor 206 be an AC servomotor presenting high output and high responsiveness.

In the present modification example, the medium encoder 215 further detects the linear velocity of the medium based on rotation of the driven roller 214b, and outputs the linear velocity to the applicator roller driver 411. Then, the applicator roller driver 411 further uses the linear velocity of the medium, which has been outputted from the medium encoder 215, to control the linear velocity of the application roller 201 through the motor 206. It is therefore possible to allow, when a medium has slipped on the application roller 201, and a linear velocity of the application roller 201 and an actual linear velocity of the medium, which is detected by the medium encoder 215, are not coincide with each other, the applicator roller driver 411 to correct rotation of the application roller 201.

### Flow of Control Operation for Application Roller

FIG. 22 is a flowchart illustrating an example of a flow of control for the application roller of the applicator of the pre-application unit in the image forming apparatus according to the first modification example. The flow of control operation for the application roller 201 of the applicator 108a of the pre-application unit 108 in the image forming apparatus 100 according to the present modification example will be described with reference to FIG. 22.

### Step S11

The applicator roller driver 411 determines whether or not a linear velocity of a medium, which has been detected by the medium encoder 215, is equal to or lower than a predetermined value. When the linear velocity of the medium, which has been detected by the medium encoder 215, is equal to or lower than the predetermined value (step S11: Yes), the processing proceeds to step S13. When the linear velocity of the medium exceeds the predetermined value (step S11: No), the processing proceeds to step S12.

### Step S12

The applicator roller driver 411 determines that the medium is normally conveyed, and continues rotation control for the motor 206 as illustrated in FIG. 21. Then, the processing returns to step S11. The applicator roller driver 411 continuously checks whether or not there is an abnormality in linear velocity of the medium.

### Step S13

When the linear velocity of the medium is equal to or lower than the predetermined value, the applicator roller driver 411 determines that an abnormality such as a paper jam has occurred, and causes the application roller 201 to stop rotating, that is, to causes the motor 206 to stop rotating. It is therefore possible to reduce the medium from being wound around the application roller 201.

In the image forming apparatus 100 according to the present modification example, as described above, the medium encoder 215 detects a linear velocity of a medium conveyed on the upstream side of the application roller 201. The applicator roller driver 411 further uses the linear velocity detected by the medium encoder 215 to control rotation of the motor 206. It is therefore possible to allow, when a medium has slipped on the application roller 201, and a linear velocity of the application roller 201 and an actual linear velocity of the medium, which is detected by the medium encoder 215, are not coincide with each other, the applicator roller driver 411 to correct rotation of the application roller 201.

### Second Modification Example

The image forming apparatus 100 according to a second modification example will be described by focusing on differences from the image forming apparatus 100 according to the embodiment described above. In the present modification example, description will be given for operation of adjusting the linear velocity Vc of the application roller 201 when a medium has reached the application roller 201 to cope with the treatment agent remaining on a surface of the application roller 201. An overall configuration, a hardware configuration, and a configuration of functional blocks in the image forming apparatus 100 according to the present modification example and a configuration of the pre-application unit 108 are similar or identical to those described in the embodiment described above.

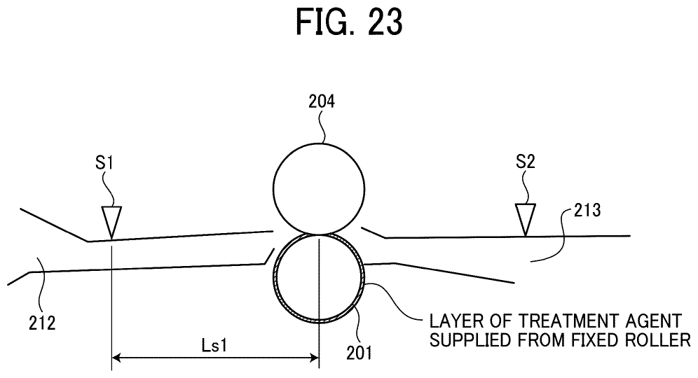

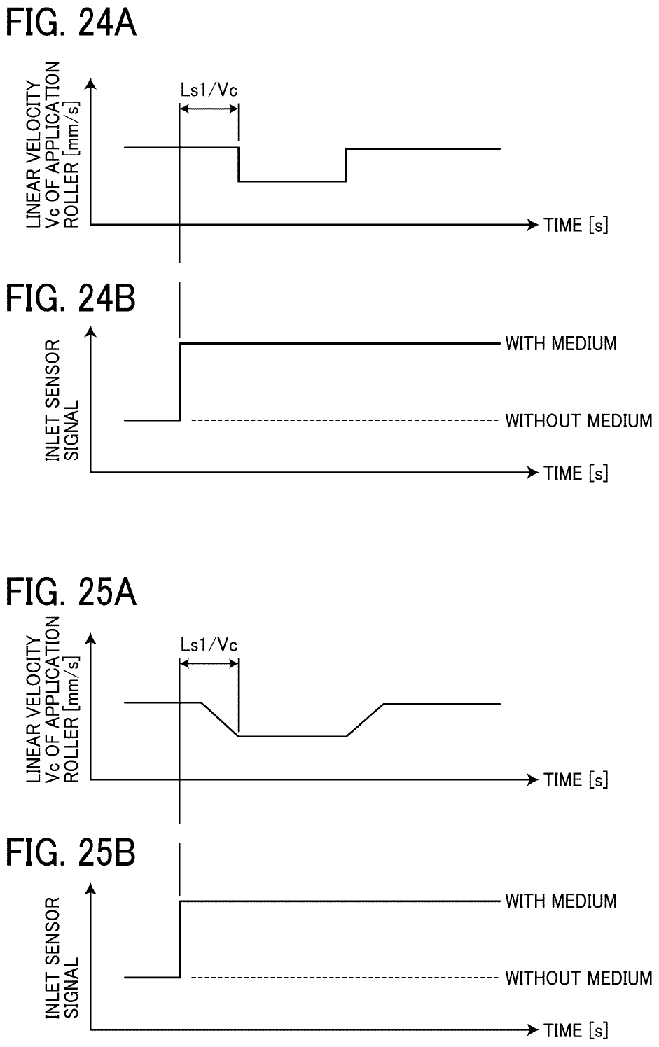

FIG. 23 is a view for describing that the treatment agent remains on the application roller of the applicator of the pre-application unit in the image forming apparatus according to the second modification example. FIGS. 24A and 24B illustrate an example of a timing for decelerating the application roller of the applicator of the pre-application unit in the image forming apparatus according to the second modification example. FIGS. 25A and 25B illustrate another example of the timing for decelerating the application roller of the applicator of the pre-application unit in the image forming apparatus according to the second modification example. Control operation for the application roller 201 of the applicator 108a of the pre-application unit 108 in the image forming apparatus 100 according to the present modification example will be described with reference to FIGS. 23 to 25.

When the application roller 201 applies the treatment agent onto a medium, the treatment agent is constantly supplied from the fixed roller 202. When there is no medium between the application roller 201 and the pressure roller 204, the treatment agent that is not applied to a medium therefore remains on the surface of the application roller 201 as illustrated in FIG. 23. An application amount of the treatment agent applied onto a front end side of the medium therefore becomes larger than an application amount of the treatment agent applied onto a rear end side. To reduce such unevenness of the treatment agent applied onto a medium, the image forming apparatus 100 according to the present modification example performs operation described below.

To reduce an application amount of the treatment agent for a predetermined period of time after the front end of a medium has reached the application position of the application roller 201, the roller controller 502 in the image forming apparatus 100 switches the linear velocity Vc to one that is lower than an optimum linear velocity specified in the lookup table illustrated in FIG. 11 to reduce the application amount. Specifically, when a distance from the inlet sensor S1 to the application position of the application roller 201 is designated as Ls1, as illustrated in FIGS. 24A and 24B, the roller controller 502 switches the linear velocity Vc of the application roller 201 to one that is lower than the optimum linear velocity after a period of time of Ls1/Vc has elapsed (that is, after the medium has reached the application position of the application roller 201) after the sensor detector 501 has detected that the inlet sensor S1 has detected the medium. Then, the roller controller 502 returns the linear velocity Vc to the original linear velocity after a predetermined period of time has elapsed after the linear velocity Vc has been switched to the one that is lower than the optimum linear velocity. It is therefore possible to reduce unevenness of the treatment agent applied onto the medium.

The inlet sensor S1 has been used to detect a medium for switching the linear velocity Vc, as described above. However, another sensor may be used.

In the example illustrated in FIGS. 24A and 24B, the roller controller 502 instantaneously changes the linear velocity Vc. However, the present embodiment is not limited to the example. When the linear velocity Vc is to be decelerated and returned to the original linear velocity, the linear velocity Vc may be gradually changed as illustrated in FIGS. 25A and 25B.

In the image forming apparatus 100 according to the present modification example, as described above, the roller controller 502 allows the application roller 201 to rotate at a linear velocity lower than an optimum linear velocity in accordance with a type of a medium for a predetermined period of time from when the medium has reached the application position of the application roller 201. It is therefore possible to reduce unevenness of the treatment agent applied onto the medium.

### Third Modification Example

The image forming apparatus 100 according to a third modification example will be described by focusing on differences from the image forming apparatus 100 according to the second modification example described above. In the present modification example, description will be given for operation of coping with the treatment agent transferred onto the second surface of a medium by the pressure roller 204 when the treatment agent is applied onto the first surface of the medium. An overall configuration, a hardware configuration, and a configuration of functional blocks in the image forming apparatus 100 according to the present modification example and a configuration of the pre-application unit 108 are similar or identical to those described in the embodiment described above.

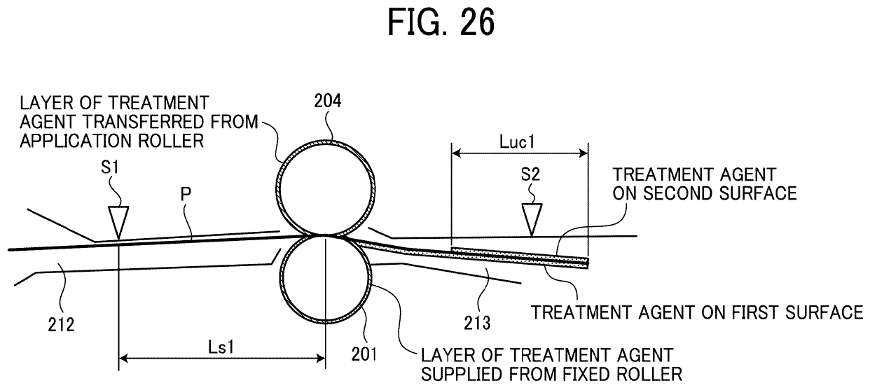

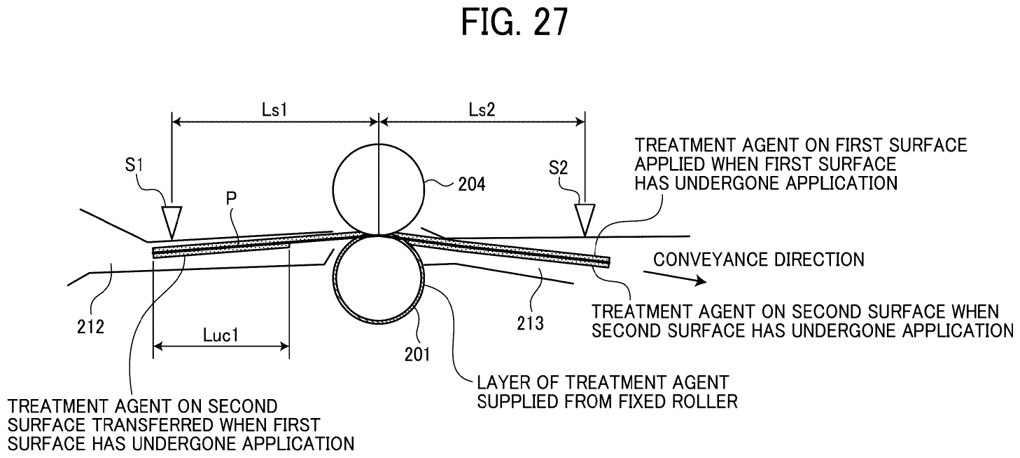

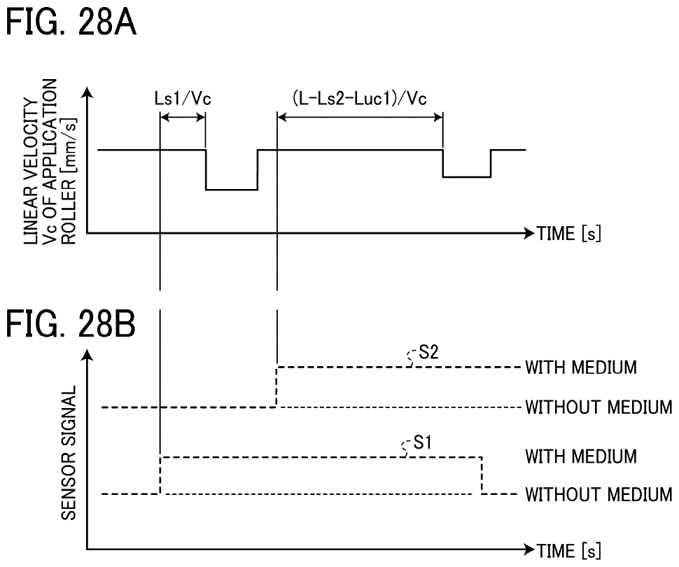

FIG. 26 is a view for describing that the treatment agent is applied onto a part of the second surface from the pressure roller of the applicator of the pre-application unit in the image forming apparatus according to the third modification example. FIG. 27 is a view for describing that a difference occurs in image quality due to application of the treatment agent onto a part of the second surface from the pressure roller of the applicator of the pre-application unit in the image forming apparatus according to the third modification example. FIGS. 28A and 28B illustrate an example of a timing for decelerating the application roller of the applicator of the pre-application unit in the image forming apparatus according to the third modification example. Control operation for the application roller 201 of the applicator 108a of the pre-application unit 108 in the image forming apparatus 100 according to the present modification example will be described with reference to FIGS. 26 to 28.

When there is no medium between the application roller 201 and the pressure roller 204, the pressure roller 204 is constantly pressed against and is in close contact with the application roller 201.

The treatment agent supplied from the fixed roller 202 to the surface of the application roller 201 is therefore transferred onto the pressure roller 204 during a period of time from when the rear end of a preceding medium has passed through the application roller 201 to when the front end of a following medium reaches the application position of the application roller 201. After the front end of a medium P has reached the application position of the application roller 201, a small amount of the treatment agent transferred onto the pressure roller 204 is therefore applied onto the second surface of the medium P, which is opposite to the first surface, as illustrated in FIG. 26. While the medium P is passing between the application roller 201 and the pressure roller 204, at this time, the treatment agent is not transferred onto the pressure roller 204, and the treatment agent adhered onto the second surface of the medium P is limited to the front end side of the medium P. In this case, a range of the treatment agent applied from the pressure roller 204 onto the second surface of the medium P is designated as a range Luc1, as illustrated in FIG. 26. When image formation printing is performed on both the sides of the medium P, application operation by the application roller 201 is then separately performed on the second surface of the medium P. As a result, as illustrated in FIG. 27, an application amount of the treatment agent onto the rear end side of the second surface (due to switching back of the medium P, the front end of the medium P when the first surface undergoes application becomes the rear end of the medium when the second surface undergoes application) becomes larger than that on the first surface, causing a difference in image quality between the first surface and the second surface. To reduce such unevenness of the treatment agent applied onto a medium, the image forming apparatus 100 according to the present modification example performs operation described below.

When the treatment agent is to be applied onto the second surface of the medium P, the roller controller 502 in the image forming apparatus 100 switches the linear velocity Vc to one that is lower than the optimum linear velocity specified in the lookup table illustrated in FIG. 11 within the range Luc1 on the second surface, onto which the treatment agent has been applied when the first surface has undergone application, to reduce an application amount onto the range Luc1 on the second surface. That is, the range Luc1 on the second surface in this case represents a predetermined range in a direction from the rear end toward the front end in the conveyance direction of the medium. Specifically, when a distance from the application position of the application roller 201 to the outlet sensor S2 is designated as Ls2, as illustrated in FIGS. 28A and 28B, the roller controller 502 switches the linear velocity Vc of the application roller 201 to one that is lower than the optimum linear velocity after a period of time of (L-Ls2-Luc1)/Vc has elapsed (that is, after the range Luc1 on the second surface of the medium P has reached the application position of the application roller 201) after the sensor detector 501 has detected that the outlet sensor S2 has detected the medium P. Then, the roller controller 502 returns the linear velocity Vc to the original linear velocity after a predetermined period of time has elapsed after the linear velocity Vc has been switched to the one that is lower than the optimum linear velocity. It is therefore possible to reduce unevenness of the treatment agent applied onto the second surface of the medium, and to reduce a difference in image quality between the first surface and the second surface.

The outlet sensor S2 has been used to detect a medium for switching the linear velocity Vc, as described above. However, another sensor may be used.

In the example illustrated in FIGS. 28A and 28B, the roller controller 502 instantaneously changes the linear velocity Vc. However, the present embodiment is not limited to the example. When the linear velocity Vc is to be decelerated and returned to the original linear velocity, the linear velocity Vc may be gradually changed.

The effect described above is similarly acquired even when the treatment agent is applied onto the second surface after the first surface has undergone image formation printing and before the second surface undergoes image formation printing in the image forming apparatus 100a illustrated in FIG. 2. In this case, when the second surface undergoes application, the treatment agent is also applied onto the front end side of the first surface having undergone image formation printing in an identical mechanism. However, the first surface has undergone image formation printing, and a contribution to its image quality is sufficiently small.

In the image forming apparatus 100 according to the present modification example, as described above, when the second surface of a medium, which is the back surface with respect to the first surface, undergoes application by the application roller 201 after the first surface of the medium has undergone application by the application roller 201, the roller controller 502 allows the application roller 201 to rotate at a linear velocity lower than an optimum linear velocity in accordance with a type of the medium, that is, a recording medium, within a predetermined range in a direction from the rear end to the front end in the conveyance direction of the medium. It is therefore possible to reduce unevenness of the treatment agent applied onto the second surface of the medium, and to reduce a difference in image quality between the first surface and the second surface.

### Fourth Modification Example

The image forming apparatus 100 according to a fourth modification example will be described by focusing on differences from the image forming apparatus 100 according to the embodiment described above. In the embodiment described above, with respect to the present modification example, description has been given for operation of allowing the roller controller 502 to refer to the lookup table stored in the storage 504, and of allowing the application roller 201 to rotate at an optimum linear velocity corresponding to a type, which has been set in advance, of a medium. In the present modification example, description will be given for construction of a neural network, through machine learning, for determining a type of a medium, for example, and for operation of using the neural network to determine the type of the medium to allow the application roller 201 to rotate at a linear velocity corresponding to the type of the medium. An overall configuration, a hardware configuration, and a configuration of functional blocks in the image forming apparatus 100 according to the present modification example and a configuration of the pre-application unit 108 are similar or identical to those described in the embodiment described above.

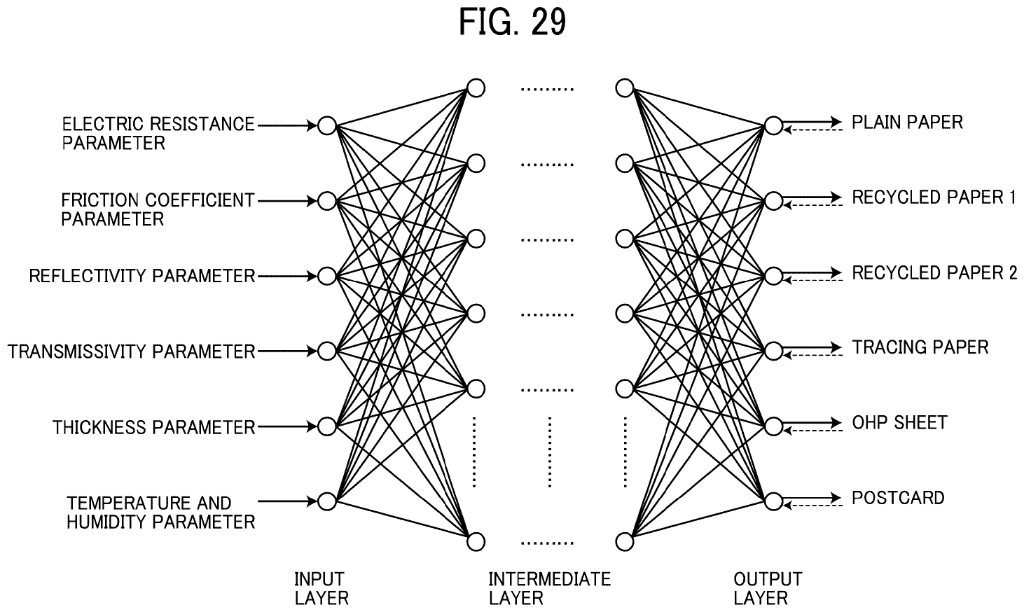

FIG. 29 is a view illustrating application of machine learning to the image forming apparatus according to a fourth modification example. Constructing a neural network for determining a type of a medium in the image forming apparatus 100 according to the present modification example, as an example of machine learning, and operation of determining the type of the medium using the neural network will be described with reference to FIG. 29. The present embodiment is not limited to use a neural network based on machine learning.

Allowing the application roller 201 to be driven at an appropriate linear velocity in accordance with a type of a medium makes it possible to provide an image with stable image quality in accordance with the type of the medium. As information of a type of a medium, known paper-type and paper-thickness sensors may be used, for example. However, using a neural network, categorizing paper, generating a parameter related to a paper characteristic, generating an operation amount suitable for the paper characteristic, and driving the application roller 201 using a result of those activities make it possible to allow the application roller 201 to be driven at an appropriate linear velocity. A neural network will be described herein for when undergoing learning and for when making determination in a separated manner.

### When Neural Network Undergoes Learning

Learning for a neural network in the roller controller 502 will first be described.

FIG. 29 illustrates an example of a hierarchical neural network constructed in the roller controller 502. As illustrated in FIG. 29, the neural network includes an input layer to which sensor information detected by various sensors is inputted, an intermediate layer, an output layer from which information of a type of a medium is outputted, and a network coupling the layers. To perform learning, an experiment is performed while changing each piece of sensor information, a correct answer is given as a teacher signal from a side where the output layer lies, and learning is performed based on a backpropagation learning rule.

In FIG. 29, flows of signals serving as teacher values are indicated by broken-line arrows.

In the present modification example, plain paper, recycled paper 1, recycled paper 2, tracing paper, overhead projector (OHP) sheet, and postcard are given as the teacher signals, for example. Through such learning, a neural network (an example of a learning model) outputting an optimum signal in consideration of input sensor information is formed between the input layer and the intermediate layer and between the intermediate layer and the output layer. It is necessary to make adjustments in the roller controller 502 in advance to receive an output from the neural network as an input and to output a control signal for an optimal device element. It is possible to perform this adjustment task in parallel to acquisition of learning data related to the neural network.

When Neural Network makes Determination

When making a determination, the constructed neural network regards, as a result of determination, an output presenting a highest degree of ignition with respect to a group of input parameters from the various sensors, and outputs a signal indicating a type of a medium. The roller controller 502 identifies the type of the medium from the output signal of the neural network. Then, the roller controller 502 refers to the lookup table described above and stored in the storage 504, and allows the application roller 201 to rotate at an optimum linear velocity corresponding to the identified type of the medium.

The roller controller 502 (circuitry) is further configured to: performing machine learning to acquire a learning model that outputs the type of recording medium; identify the type of recording medium to be conveyed to the application roller by using the type of recording medium output from the learning model; and refer to the table in the storage; and control the drive circuit to rotate the application roller at a linear velocity corresponding to the type of recording medium identified by the circuitry.

In the present modification example, it is also possible to provide a correct answer related to a type of a medium to the neural network as a teacher value and to perform additional learning while the user is using the image forming apparatus 100, if necessary, to construct a neural network for determining a type of a medium, in response to an environmental change and variation in the image forming apparatus 100, for example.

In the image forming apparatus 100 according to the present implementation example, as described above, the roller controller 502 uses a neural network acquired through machine learning for outputting a type of a medium, identifies a type of a medium to be conveyed to the application roller 201, refers to the lookup table, and allows the application roller 201 to rotate at a linear velocity corresponding to the identified type of the recording medium. It is therefore possible to accurately identify a type of a medium to be conveyed to the image forming apparatus 100, and to switch a linear velocity to an optimum linear velocity in accordance with the medium.

In the embodiment and the modification examples described above, when at least one of the functional portions in the image forming apparatus 100 or 100a is implemented by executing a program, the program is provided by being incorporated in advance in the ROM, for example. In the embodiment and the modification examples described above, the program executed by the image forming apparatus 100 or 100a may be provided by being recorded in a computer-readable recording medium such as a compact disc read only memory (CD-ROM), a flexible disk (FD), a compact disk-recordable (CD-R), or a digital versatile disc (DVD) as a file in an installable format or an executable format. In the embodiment and the modification examples described above, the program to be executed by the image forming apparatus 100 or 100a may be stored on a computer coupled to a network such as the Internet, and may be provided by being downloaded via the network. In the embodiment and the modification examples described above, the program to be executed by the image forming apparatus 100 or 100a may be provided or distributed via a network such as the Internet. In the embodiment and the modification examples described above, the program to be executed by the image forming apparatus 100 or 100a has a module configuration including at least one of the functional portions described above. As actual hardware, the CPU 401 reads and executes the program from the storage device described above (for example, the ROM 402 or the NVRAM 404) to allow the functional portion described above to be loaded and generated on a main storage device (the RAM 403).

Aspects of the present embodiment are as follows.

According to a first aspect, a treatment agent applicator includes: an application roller that applies a treatment agent onto a recording medium that is to be conveyed; a driver that rotationally drives the application roller; a first encoder that detects a rotational speed of the driver; a first drive circuit that uses the rotational speed detected by the first encoder to perform feedback control on the driver to enable changing of a linear velocity of the application roller; and a first controller that controls operation of the first drive circuit, in which the first controller switches the linear velocity of the application roller via the first drive circuit in accordance with a type of the recording medium.

According to a second aspect, in the treatment agent applicator of the first aspect, the driver is an alternating current (AC) servomotor.

According to a third aspect, the treatment agent applicator of the first aspect or the second aspect further includes a storage that stores a table in which an optimum linear velocity of the application roller is associated with each type of the recording medium, in which the first controller refers to the table stored in the storage, and allows the application roller to rotate at a linear velocity corresponding to the recording medium conveyed to the application roller.

According to a fourth aspect, in the treatment agent applicator of the third aspect, the first controller uses a learning model acquired by performing machine learning to output a type of the recording medium to identify the type of the recording medium to be conveyed to the application roller, and refers to the table to allow the application roller to rotate at a linear velocity corresponding to the identified type of the recording medium.

According to a fifth aspect, the treatment agent applicator of the first aspect to the fourth aspect further includes a second encoder that detects a linear velocity of the recording medium conveyed on an upstream side of the application roller, in which the first drive circuit further uses the linear velocity detected by the second encoder to control rotation of the driver.

According to a sixth aspect, in the treatment agent applicator of the fifth aspect, the first drive circuit determines whether or not the linear velocity detected by the second encoder is equal to or lower than a predetermined value, and causes the application roller to stop rotation when the linear velocity detected by the second encoder is equal to or lower than the predetermined value.

According to a seventh aspect, in the treatment agent applicator of the first aspect to the sixth aspect, the first controller causes the application roller to rotate at a linear velocity lower than a linear velocity corresponding to a type of the recording medium for a predetermined period of time from when the recording medium has reached an application position of the application roller.

According to an eighth aspect, in the treatment agent applicator of the first aspect to the seventh aspect, the first controller causes the application roller to rotate at a linear velocity lower than a linear velocity corresponding to a type of the recording medium within a predetermined range in a direction from a rear end to a front end, in a conveyance direction, of the recording medium when a first surface of the recording medium first undergoes application by the application roller, and then a second surface of the recording medium, the second surface being a back surface with respect to the first surface, undergoes application by the application roller.

According to a ninth aspect, the treatment agent applicator of the first aspect to the eighth aspect further includes: a plurality of conveyance rollers that is disposed upstream and downstream of the application roller and conveys the recording medium; a second drive circuit that rotationally drives the plurality of conveyance rollers independently; and a second controller that controls operation of the second drive circuit, in which the second controller controls rotation of the plurality of conveyance rollers to convey the recording medium at a linear velocity corresponding to a type of the recording medium at least within a range of a length, in a conveyance direction, of the recording medium on an upstream side from an application position of the application roller and within the range of the length on a downstream side from the application position.

According to a tenth aspect, an image forming apparatus includes: the treatment agent applicator of the first aspect or the second aspect; and a discharge head that discharges ink onto the recording medium applied with the treatment agent by the treatment agent applicator to form an image.

Any one of the above-described operations may be performed in various other ways, for example, in an order different from the one described above.

The functionality of the elements such as the wiper cleaner controller 95 disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Preferred embodiments of the present embodiment have been described above, but the present embodiment is not limited to such particular embodiments. Unless otherwise particularly limited in the above description, various modifications and alterations may be made without departing from the scope of the gist of the present embodiment in the claims.

The effects described in the embodiments of the present embodiment are merely examples of the most preferable effects generated from the present embodiment. Thus, the effects of the present embodiment are not limited to the effects described in the embodiments of the present embodiment.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A treatment agent applicator comprising:
an application roller to apply a treatment agent onto a recording medium conveyed in a conveyance direction;
a driver to rotate the application roller;
an encoder to detect a rotational speed of the driver;
a drive circuit configured to perform feedback control on the driver to switch a linear velocity of the application roller based on the rotational speed detected by the encoder; and
circuitry configured to control the drive circuit to switch the linear velocity of the application roller according to a type of recording medium.

2. The treatment agent applicator according to claim 1,
wherein the driver includes an alternating current servo motor.

3. The treatment agent applicator according to claim 1, further comprising:
storage to store a table in which an optimum linear velocity of the application roller is associated with each type of recording medium,
wherein the circuitry is further configured to:
refer to the table stored in the storage; and
control the drive circuit to rotate the application roller at a linear velocity corresponding to the type of recording medium conveyed to the application roller.

4. The treatment agent applicator according to claim 3,
wherein the circuitry is further configured to:
performing machine learning to acquire a learning model that outputs the type of recording medium;
identify the type of recording medium to be conveyed to the application roller by using the type of recording medium output from the learning model; and
refer to the table in the storage; and
control the drive circuit to rotate the application roller at a linear velocity corresponding to the type of recording medium identified by the circuitry.

5. The treatment agent applicator according to claim 1, further comprising:
another encoder to detect a linear velocity of the recording medium conveyed on a conveyance path upstream of the application roller,
wherein the drive circuit controls a rotation of the driver based on the linear velocity detected by said another encoder.

6. The treatment agent applicator according to claim 5,
wherein the drive circuit:
determines whether the linear velocity detected by said another encoder is equal to or lower than a predetermined value; and
controls the application roller to stop rotation when the linear velocity detected by said another encoder is determined to be equal to or lower than the predetermined value.

7. The treatment agent applicator according to claim 1,
wherein the circuitry controls the drive circuit to rotate the application roller at a linear velocity lower than a linear velocity corresponding to the type of recording medium for a predetermined period after the recording medium reaches an application position of the application roller where the application roller applies the treatment agent onto the recording medium.

8. The treatment agent applicator according to claim 1,
wherein the circuitry is further configured to:
control the drive circuit to rotate the application roller at a linear velocity lower than a linear velocity corresponding to the type of recording medium within a predetermined range from a rear end of the recording medium in the conveyance direction, to:
apply the treatment agent onto a first surface of the recording medium by the application roller; and
apply the treatment agent onto a second surface of the recording medium opposite to the first surface by the application roller after applying the treatment agent onto the first surface.

9. The treatment agent applicator according to claim 1, further comprising:
multiple conveyance rollers in a conveyance path upstream and downstream of the application roller, multiple conveyance rollers to convey the recording medium;
another drive circuit configured to rotate the multiple conveyance rollers, independently; and
another circuitry configured to control said another drive circuit,
wherein said another circuitry controls a rotation of the multiple conveyance rollers to convey the recording medium at a linear velocity corresponding to the type of recording medium,
at least in a range:
from an application position of the application roller to a point upstream of the application position for a length of the recording medium in the conveyance direction, and
from the application position to a point downstream of the application position for the length of the recording medium in the conveyance direction.

10. An image forming apparatus comprising:
the treatment agent applicator according to claim 1; and
a discharge head to discharge ink onto the recording medium applied with the treatment agent by the treatment agent applicator to form an image on the recording medium.
